(19) United States
(12) Patent Application Publication
(10) Pub. No.: US 2010/0161377 A1
(43) Pub. Date: Jun. 24, 2010

(54) EXPANDING A USER BASE FOR AN INFORMATION EXCHANGE SERVICE

(75) Inventors: Tara Hines, McKinney, TX (US); James Austin Britt, Manor, TX (US); Joshua J. Fox, Austin, TX (US); Adam Klein, Cedar Park, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/341,802

(22) Filed: Dec. 22, 2008

(51) Int. Cl. G06Q 30/00; G06Q 50/00

(52) U.S. Cl. 705/10; 705/14.49

(57) ABSTRACT

A process for expanding a targeted service includes a subscription expansion application determining the information exchange services that an existing service user (ESU) uses. The application may then access the ESU's various contacts lists and/or address books to develop an initial list of prospective service users (PSUs). The ESU may specify which contact lists the application is authorized to access. The application may then filter the PSUs based on geographic availability of the targeted service. The application may then generate and send invitations to PSUs inviting PSUs to subscribe to the targeted service. The invitations may identify the ESU and may be sent electronically or by mail. The application may monitor new subscription requests attributable to an ESU's invitations. The ESU may be compensated by the service provider based on the number of new service requests. The compensation may include direct monetary compensation and/or reward points in an affinity program.

### BACKGROUND

1. Field of the Disclosure

The disclosed subject matter relates to information exchanges services including, e.g., data services, voice services, wireless services, and video or multimedia services. More particularly, the disclosed subject matter is concerned with increasing the user base or subscription base for an information exchange service.

2. Description of the Related Art

Competition for providers of various information exchange services including voice, data, video or multimedia, and wireless is fierce and likely to increase. Competitors are likely to create increasingly more compelling offers whenever one provider gains or is perceived to gain a technological and/or marketing edge with respect to a given service. “Stickiness” is a marketing term that refers to the reluctance with which subscribers and other users are willing to switch from an existing service to a competing service and/or an upgraded service. Competitors seek to increase their base of subscribers while simultaneously enhancing the stickiness of their services to minimize or reduce subscriber “churn.”

### BRIEF DESCRIPTION OF THE DRAWINGS

FIG. 1 is a block diagram of selected elements of an exemplary network suitable for practicing disclosed methods;

FIG. 2 is a block diagram emphasizing selected aspects of the network of FIG. 1;

FIG. 3 is a flow diagram illustrating selected elements of an embodiment of a method for implementing a compensation-based method for leveraging existing users' contact lists, personal networks, and the like to drive a subscription expansion promotion; and

FIG. 4 is a block diagram of selected elements of an exemplary data processing system suitable for practicing methods including the method of FIG. 3.

### DESCRIPTION OF EXEMPLARY EMBODIMENTS

The subject matter disclosed herein includes methods, which may be implemented in computer software, enabling service providers to leverage the personal networks of their existing subscribers and other service users to expand and target efforts to increase the subscription base and/or user base of a targeted service. Once a subscriber “opts in,” the personal network information for existing subscribers/users is accessed. The personal network information may include, for example, information contained in a plurality of contact lists and/or address books associated with a variety of information exchange services.

An existing subscriber/user may use data, voice, and wireless services and may have contact lists associated with each of them. The existing user may indicate which of the user's contact lists/individual contacts/contact types the user wishes to approve for inclusion in a subscription expansion promotion. The initial set of individuals listed in the approved contact lists represent an initial set of prospective subscribers/users. The prospective users may be filtered based on eligibility for the targeted service to remove individuals who either already subscribe to the service or are ineligible to receive the service. An invitation may then be generated and sent to prospective users inviting them to subscribe to the targeted service.

The number of new users resulting from such invitations may be monitored by the provider of the targeted service or by a third party. The existing users, as well as any new users, may be compensated based on the number of new service requests to encourage further user-driven recruiting efforts. Additional programs or service features can be implemented to encourage participation, minimize service switching and reduce churn. By offering existing users incentives to encourage the enlistment of new users, the disclosed methods may enable an emerging provider to overcome barriers to switching that consumers may otherwise exhibit. Invitations from friends and peers may alleviate apprehension to switching while simultaneously fostering a user community that reduces subscriber chum. For example, leveraging personal networks of existing users as a base for targeting marketing efforts may provide the foundation for relevant enhancements such as IPTV chat, sharing of recently viewed programs/photos/favorites guides, etc.

In one aspect, a disclosed method for increasing subscriptions and/or expanding a user base of a targeted service may include enabling an existing service user (ESU) to indicate a desire to participate in or consent to a subscription expansion promotion (SEP). After an ESU indicates a desire or consent to participate in the SEP, a service expansion application may determine the information exchange services that the ESU currently subscribes to or otherwise uses. The service expansion application may then retrieve contacts lists, address books, or other forms of information identifying the family, friends, colleagues, peers, and acquaintances of an ESU. In some embodiments, the ESU is enabled to specify which contact lists/contact types and individual contacts the service provider is authorized to access as part of the expansion effort. The service expansion application may then filter the contacts retrieved from the ESU's personal networks to eliminate those who may already subscribe to the targeted service those who may not be eligible for the targeted service.

After creating and refining the list of prospective users associated with an ESU, the service provider may then generate personalized or general invitations to subscribe to or otherwise use the targeted service. The invitations may indicate the name or otherwise identify the ESU. The invitations may, for example, originate from an email address or other address associated with the ESU. The invitations may then be sent electronically, by paper, or otherwise to the prospective users.

The service expansion application may monitor new subscription requests attributable to the invitations. In this manner, the service expansion application may be able to associate new subscriptions with ESUs. The service expansion application may then rank or otherwise rate the ESU based on the ESU's performance in recruiting new users and the service provider may compensate the ESU based on the ranking or rating. The compensation may include monetary compensation, e.g., a reduction of a monthly service bill and/or reward points in an affinity program.

The targeted service might be a multimedia content delivery (MCD) service including, e.g., an Internet protocol television (IPTV) service. In addition to IPTV or another multimedia service, the services that the ESU subscribes to or uses may include fixed access voice services, broadband Internet services (data services), wireless telephony services.

In another aspect, a disclosed method for promoting a service includes accessing information stored in a plurality of service-specific electronic address books of a service user to identify an initial group of potential users. The method may further include determining which of the potential subscribers are eligible to receive a targeted service and sending electronic invitations to the eligible potential users inviting them to subscribe to the targeted service or to a trial of the targeted service. The invitations may be electronic, paper, or in some other form. The identity of the existing service user may be indicated in the invitations. New subscription requests received in response to the invitations are monitored and compensation to existing service users may be provided based on the number of new subscriptions associated with a particular existing user.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

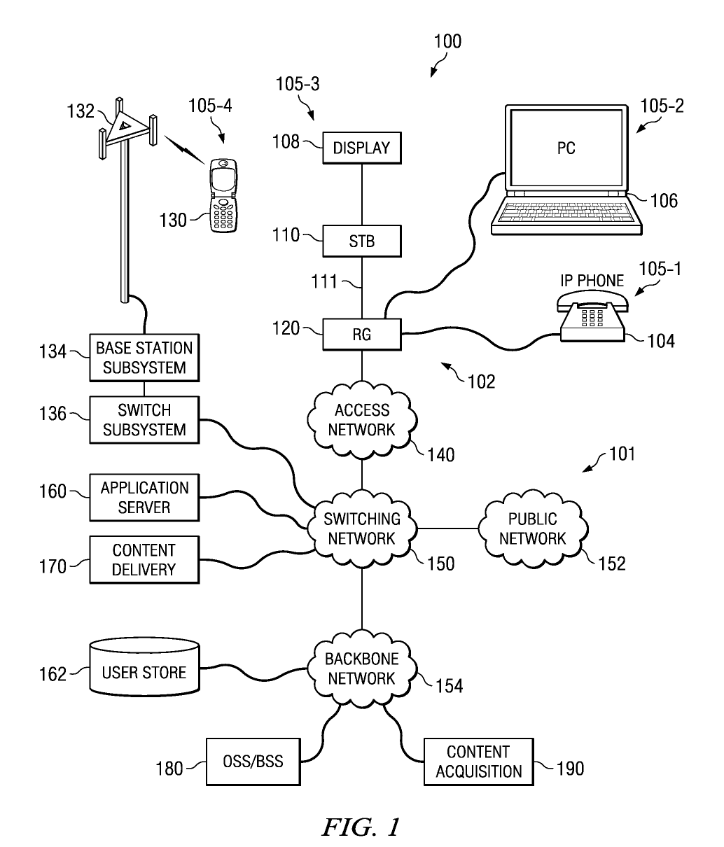

Referring to FIG. 1, selected elements of a network 100 suitable for providing one or more information exchange services (IESs) are depicted. In the depicted embodiment, network 100 emphasizes IESs 105 that are provided to a user associated with household 102. The IESs 105 may all be provided by a single provider such as AT&T. In other cases, different providers provide different IESs. The user of IESs may also be a subscriber of those services and the terms “subscriber” and “subscriptions” may be used herein to emphasize that, in some implementations, IESs are provided to a subscriber/user based on a subscription that may carry with it a service contract as well as periodic charges that the subscriber/user agrees to pay.

Network 100 as depicted in FIG. 1 illustrates a household 102 that uses four different IESs 105. The IESs 105 provided to household 102 include a fixed access voice service 105-1, a Internet/data service 105-2, a multimedia content delivery service 105-3, and a wireless telephony service 105-4. In FIG. 1, each of the IESs 105 are represented by a corresponding customer premises equipment device. Fixed access voice service 105-1, for example, is represented by an IP telephone 104, Internet/data service 105-2 is represented by a personal computer 106, multimedia content delivery service 105-3 is represented by a set top box 110 and a display 108, and wireless telephony service 105-4 is represented by a wireless telephony device 130.

In the embodiment depicted in FIG. 1, all of the IESs 105 are provided to household 102 by a single service provider, namely, service provider 101. A combination of two or more service providers may provide the IESs 105 to household 102 in other embodiments. As depicted in FIG. 1, household 102 receives three of the IESs 105, the “wired” IESs, through an access network 140 and a residential gateway 120. Specifically, fixed access voice service 105-1, Internet/data service 105-2, and multimedia content delivery service 105-3 are provided via access network 140 and residential gateway 120. In other embodiments, the wired IESs may be provided by a combination of two or more service providers. Wireless telephony service 105-4, on the other hand, is provided via a cellular telephone access network that includes a base station tower 132 connected to a base station subsystem 134 and a switch subsystem 136 that is integrated within service provider 101 via switching network 150 and backbone network 154.

Residential gateway 120, set top box 110, and display 108 cooperate to provide IPTV services or another form of multimedia content delivery service 105-3 to household 102. Residential gateway 120 may include elements of a conventional DSL modem combined with an access point/router that supports an IP compliant local area network 111 in household 102. Residential gateway 120 may further include wireless access point functionality to enable a wireless extension of local area network 111. Local area network 111 may be compliant with an industry standard network protocol including, for example, any of the IEEE 802-family of standards.

Access network 140 encompasses the physical layer and network that extends to household 102. In some embodiments, access network 140 includes DSL compliant twisted copper cables extending to household 102. In other embodiments, access network 140 may include fiber optic cables, coaxial cables, and other types of physical layer media. Access network 140 provides a demarcation between household 102 and service provider 101.

Service provider 101 as depicted in FIG. 1 includes a switching network 150 that interconnects an application server 160 and content delivery resources 170 to a backbone network 154. Switching network 150 is also shown connected to a public network 152. Public network 152 may encompass various public networks, including the Internet, that are compliant with the Internet protocol or another suitable network layer protocol. A user store 162, an OSS/BSS 180, and a content acquisition resources 190 are shown connected to backbone network 154. Backbone network 154 is a high bandwidth, e.g., Ti capacity, high reliability network that may carry an enormous amount of service provider data including data and content requested by and exchanged between end users.

OSS/BSS 180 includes OSS (operations support subsystem) components, which generally refer to network-focused systems and resources for supporting processes such as maintaining network inventory, provisioning services, configuring network components, and managing faults. OSS/BSS 180 further includes BSS (business support subsystem) components, which generally refer to business-focused systems for providing customer service, taking orders, processing bills, and collecting payments.

Content acquisition resources 190 encompasses devices and/or resources for capturing multimedia content including live content such as broadcast and national feed television channels as well as time shifted content such as video on demand and pay per view content. Content acquisition resources 190 may further encompass resources for capturing music or other audio programming content. Content acquisition resources 190 may deliver and cache captured content in regional or local “head ends” (not depicted in FIG. 1).

In some embodiments, content acquisition resources 190 operate in conjunction with content delivery resources 170 to deliver IPTV compliant multimedia content services to household 102. Content delivery resources 170, in addition to processing content provided by content acquisition resources 190 for delivery to end users via access network 140, may include resources for injecting local or regional content including advertising content, local news content, and so forth.

Application server 160 encompasses features and applications provided to household 102 by service provider 101. Although application server 160 is depicted as a single element in FIG. 1, application server 160 may include multiple physical servers and/or other distributed computing resources. Moreover, applications supported or provided by application server 160 may be downloaded to local devices such as PC 106 and/or set top box 110 or otherwise operated in a distributed manner. A user store 162 is shown connected to backbone network 154. User store 162 may include profile information for subscribers and other users. User store 162 may also include directory information enabling an application to associate an identity, e.g., the name of a person, with an electronic address including, as examples, an email address, a telephone number, a cellular number, an SMS (text) number, and so forth.

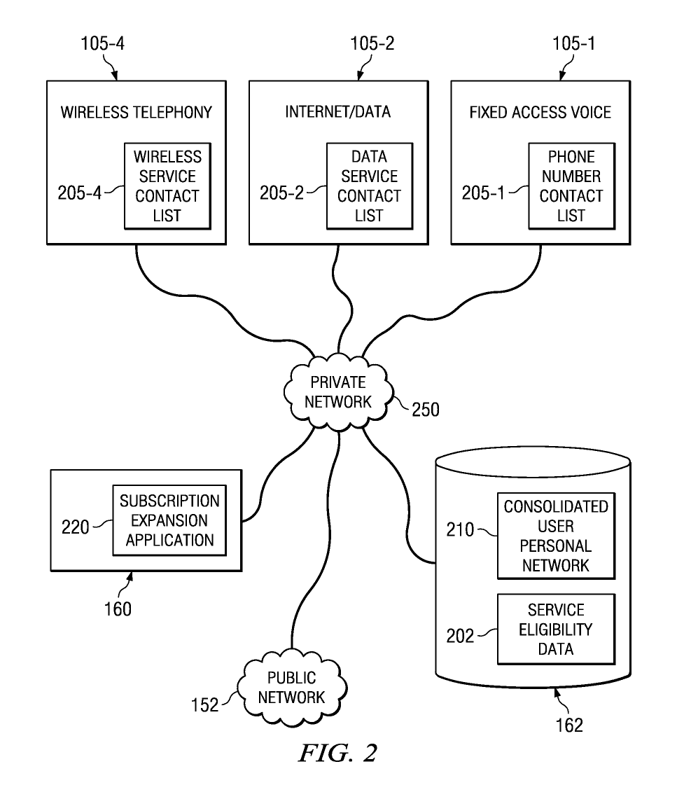

Turning now to FIG. 2, additional detail of selected aspects of network 100 as depicted in FIG. 1 are illustrate to emphasize functionality for leveraging the various sources of personal network information that an existing user may have or have access to. An existing user's personal network information may be leveraged in the described manner for purposes of developing targeted marketing efforts including, e.g., marketing efforts to encourage and/or enlist existing users to send invitations or otherwise initiate marketing communications within their personal or social network groups. The marketing communications initiated by an existing user might include an invitation from the existing user to a member of the existing user's personal network. The invitation might encourage the prospective user to subscribe to or otherwise use a targeted service provided by service provider 101.

As depicted in FIG. 2 a subscription expansion application 220 stored on application server 160 may communicate, via a private network 250, with various IESs 105 provided to household 102 including, in the depicted implementation, fixed access voice service 105-1, Internet/data service 105-2, and wireless telephony service 105-4. In FIG. 2, private network 250 is connected to public network 152 and may encompass some or all of access network 140, switching network 150, and backbone network 154.

Subscription expansion application 220 may operate in conjunction with personal network information associated with an existing user or household such as household 102 (FIG. 1). FIG. 2 illustrates a user's personal network information distributed among at least three data structures, namely, a phone service contact list 205-1, a data service contact list 205-2 and a wireless service contact list 205-4. Contact lists 205 emphasize the a user's personal network information may be distributed among two or more different types of services and may be stored in two or more files or databases and formatted according to two more different types of protocols, e.g., data service contact list 205-2 may be an email contact list associated with email address information while phone service contact list 205-1 may be associated with conventional telephone number information.

In some embodiments, subscription expansion application 220 accesses a household 102 and retrieves contact lists and/or other types of personal network information associated with the household from a plurality of devices associated with a plurality of different services. Subscription expansion application 220 may retrieve contact lists and other personal network information from household 102 to develop an initial list of prospective service users (PSUs) for a targeted service such as an IPTV or other multimedia content delivery service. In other words, the PSUs represent the identities of individuals or households that are being identified for a targeted marketing effort in conjunction with a targeted service or other offering from service provider 101.

Subscription expansion application 220 may have access to data structures in user store 162 including, as depicted in FIG. 2, service eligibility data 202 and a consolidated personal network data 210. Service eligibility data 202, as its name suggests, may include information indicative of geographical regions where a particular service is currently available. Many types of IESs have bandwidth requirements that place constraints on the physical realities of the access network including, constraints on how far a household 102 can be from a central office or node or other element of access network 140. The service eligibility data 202 may include information enabling subscription expansion application 220 to determine if an individual identified in as a PSU is eligible to receive the service. In these embodiments, subscription expansion application 220 may index or otherwise access service eligibility data 202 using an address or other piece of identifying information for a PSU to receive an indication of whether the targeted service is available to the PSU. Subscription expansion application 220 may also access data structures (not depicted) indicating a list of existing users for the targeted service so that subscription expansion application 220 can eliminate existing subscribers from the list of PSUs.

User store 162 as shown in FIG. 2 may further include consolidated personal network data 210. Consolidated personal network data 210 may represent a data structure compiled by service provider 101 containing personal network information from multiple sources, e.g., multiple contact lists.

One aspect of subscription expansion application 220 emphasized in FIG. 2 is the ability of subscription expansion application 220 to access service-specific contact lists. For example, phone service contact list 205-1 is specific to fixed access voice service 105-1, data service contact list 205-2 is specific to Internet/data service 105-2, and wireless service contact list 205-4 is specific to wireless telephony service 105-4. Subscription expansion application 220 generates an initial list of PSUs by accessing each of the contact lists 205 individually.

A benefit derived by accessing contact lists 205 individually is the ability to allow the user to specify which portions of the user's personal network the user wishes to involve in a subscription expansion effort or any other form of marketing effort. If, for example, Internet/data service 105-2 is primarily dedicated to the user's employment and fixed access voice service 105-1 and wireless telephony service 105-4 are substantially dedicated to the user's personal endeavors, the user may not wish to expose the user's business contacts to the marketing effort. In this case, the user may offer phone service contact list 205-1 and wireless service contact list 205-4 to subscription expansion application 220, but decline to permit the use of data service contact list 205-2.

Although subscription expansion application 220 needs associate an address with each PSU, FIG. 2 does not depict a data structure containing profile or identity information for the PSUs extracted from the contact lists 205. In some embodiments, subscription expansion application 220 may use contact information contained in one of the applicable contact lists 205. For example, data service contact list 205-2 presumably contains, at a minimum, a name and email address for each of the user's email contacts. In this case, subscription expansion application 220 may use email addresses as the delivery address for invitations to PSUs extracted from data service contact list 205-2. Similarly, subscription expansion application 220 may use SMS addresses for contacts in wireless service contact list 205-4 and so forth.

In some embodiments, the user or the service provider may wish to specify the form of the invitation. For example, the user and/or service provider may wish to send paper invitations by postal service mail. In such cases, subscription expansion application 220 may have to access external data to attempt to resolve a mailing address for a PSU contact that is identified only by an email address, SMS address, and/or phone number. Although not depicted in FIG. 2, subscription expansion application 220 may include functionality to access external directory listing databases or services via private network 250 and/or public network 152. When subscription expansion application 220 encounters an entry in a contact list that does not supply addressing information in a format that subscription expansion application 220 desires or requires, such as the mailing address in the previous example, subscription expansion application 220 may access an external directory listing service or database to retrieve the required addressing information. Subscription expansion application 220 may then store the acquired addressing information in consolidated personal network 210 for later use.

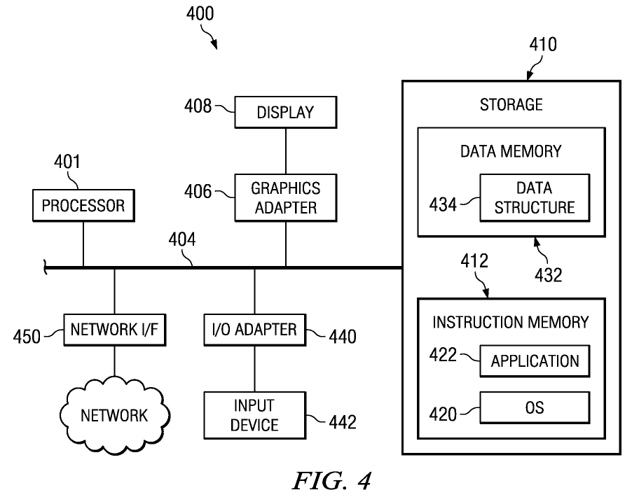

As already suggested by subscription expansion application 220, some aspects of the subscriber expansion techniques disclosed herein may be implemented as computer software or devices that execute computer software. In these cases, computer software may be embodied as a set of computer executable instructions stored on a computer readable storage medium such as the storage medium storage 410 depicted in FIG. 4. When executed by a processor or other suitable device, the instructions cause the processor to perform a specified sequence of actions. Computer software may be illustrated as a flow diagram where the flow diagram blocks represent actions performed by the processor or device executing the software instructions.

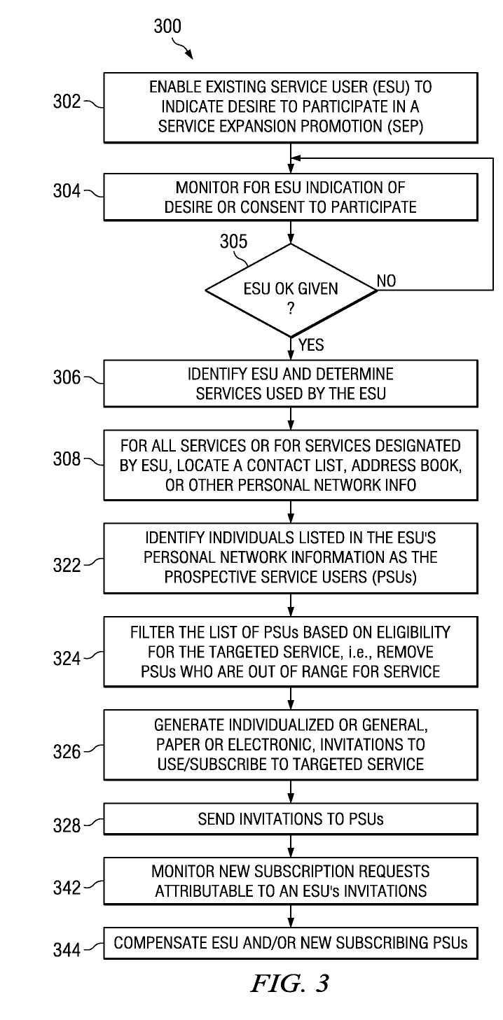

Referring now to FIG. 3 a flow diagram depicts selected elements of an embodiment of a method 300 for implementing a user-driven promotion to expand the user base or subscription base associated with a service offered by a service provider. Method 300 as depicted may include elements in common with actions performed by subscription expansion application 220.

In the depicted embodiment, method 300 includes enabling (block 302) an existing service user (ESU) to indicate a desire to participate in a service expansion promotion (SEP). Method 300 as shown further includes monitoring (block 304) for the ESU's indication of a desire or consent to participate in an SEP. Blocks 302 and 304 are applicable to embodiments that offer existing users the opportunity to decline to participate in an SEP. Some embodiments may condition participation in one or more SEPs as a prerequisite to obtaining an IES and, in such embodiments, blocks 302 and 304 may be bypassed in method 300.

When an ESU's consent is given (block 305), method 300 then identifies (block 306) the ESU and determines the IESs used by the ESU. The ESU's identity may be conveyed explicitly or impliedly in the ESU's election to participate in the SEP. The determination of IESs used by the ESU may include determining the services to which the ESU has subscribed and/or registered. In still other embodiments, the services used by an ESU may be determined by from data structures stored on customer premises equipment such as residential gateway 120 depicted in FIG. 1.

After determining which IESs an ESU uses, method 300 as shown then locates (block 308) a contact list, address book, or other form of data containing personal network information. More specifically, method 300 as shown locates a contact list for each IES that the ESU authorizes for participation in the SEP. This embodiment supports ESU ability to specify which of the IES that the ESU consumes are to be included in the SEP. Other embodiments may not support such a feature. In these cases, method 300 may locate a contact list or the like for each IES that the ESU uses.

Method 300 as shown further includes identifying (block 322) individuals listed in the contact lists located in block 308. The individuals identified in block 322 may serve as an initial list of prospective service users (PSUs). The PSUs represent the individuals to whom the SEP is primarily directed. As discussed previously, identifying individuals included in a contact list may mean associating the individual with an address, electronic or otherwise. The address with which an individual is associated may be an email address, an SMS address, or telephone number, or a street address.

In some cases, it is desirable to associated PSUs with physical address such as street addresses because the availability of services may be a function of where the PSU is located. For many broadband based service, as an example, bandwidth limitations of the access network impose geographical restrictions on eligibility for certain services. Method 300 as depicted includes filtering (block 324) the initial list of PSUs based on eligibility for the targeted service, i.e., the service targeted for expansion by SEP. Block 308 may include removing certain PSUs from the initial list when a PSU's residence address is not eligible to receive a targeted service.

After filtering the PSU list and removing candidates that are not eligible to receive the targeted services, method 300 as shown includes generating (block 326) invitations to subscribe to, register with, or otherwise use a targeted service. The invitations may be individualized or not. The invitations may, however, include an indication of the ESU's identity to personalize the invitation from the PSU's perspective. Thus, for example, the invitations may or may not include individualized greetings, e.g., “Dear Lucy,” or “Hi Rico!”. Similarly, invitations may or may not include a personalized signature block, e.g., “Sincerely Yours, ESU”.

The invitations may be paper invitations and may include substantially any desired level of simplicity or complexity. Invitations may also be electronic invitations that are delivered via email, text message, and so forth.

Method 300 as depicted further includes monitoring (block 342) new subscription requests and attributing new subscription requests to specific invitations wherever possible. In the case of paper invitations, for example, the invitations may include a return postcard insert that can be used to identify the invitation and the corresponding ESU in the event that the PSU who received the invitation ultimately subscribes to the targeted service. In the event that the PSU decides to accept a paper invitation with an electronic reply, e.g., via a Web site or via email, the invitation may include an identifying serial number that the user may indicate when the response is submitted.

In some embodiments, ESUs and PSUs may be given incentives to enlist PSUs by compensating (block 344) ESUs when PSUs respond positively to invitations signed by the ESU. Similarly, PSUs may be motivated to respond to an invitation by offering the PSU some form of reward or compensation, especially when the decision to become a new subscriber necessitates the ESU from terminating an analogous service provided by an existing service provider.

The compensation provided to ESUs and/or may come in any of various forms. Cash rebates, for example, may be provided to ESUs based on the number of new subscription requests resulting from invitations bearing the ESU's signature or otherwise associated with the ESU. As an alternative to cash rebates, ESU compensation may include a discount on an ESU's monthly bill from the service provider. In still other embodiments, compensation may be in the form of rewards points associated with an affinity program where the reward points are exchangeable for goods and/or services.

Referring now to FIG. 4, a block diagram of selected elements of a data processing system 400 is presented. Data processing system 400 as depicted in FIG. 4 is an exemplary general purpose data processing system that encompasses the data processing systems depicted in FIG. 1 including, as examples, Internet/data service 105-2 and application server 160. In the depicted embodiment, data processing system 400 includes a processor 401 and a computer readable storage 410 accessible to processor 401 via a bus 404.

Storage 410 encompasses various types of computer memory media including volatile memory such as dynamic and static random access memory, persistent memory including magnetic drives, solid state drives, flash memory, read only memories including programmable and/or erasable read only memories, optical storage media such as compact discs and digital versatile discs, magnetic tape media and so forth. Storage 410 is operable to store programs, i.e., computer executable instructions, and data and data processing system 400 as depicted in FIG. 4 includes an instruction memory 412 and a data memory 432. Although FIG. 4 distinguishes between instruction memory 412 and data memory 432, this distinction may be an organizational distinction only and may or may not reflect a distinction in terms of any physical, logical, or virtual architecture. Instruction memory 412 as shown includes an operating system 420 and an application 422 while data memory 432 is shown as including a data structure 434. Application 422 may represent substantially any application executable by data processing system 400 including, for example, subscription expansion application 220 of FIG. 2.

Data processing system 400 as shown in FIG. 4 further includes a graphics adapter 406, a network interface 450 and an I/O adapter 440 all connected to bus 404. Graphics adapter 406 controls a display 408 to provide visual output in the form of computer graphics including graphical user interfaces, still video images, video streams, and so forth. Network interface 450 is operable to connect data processing system 400 and processor 401 to an external network including any IP based network such as the Internet, a corporate intranet, an Ethernet-based local area network, and so forth. I/O adapter 440 interfaces with an input device 442 including keyboards, point devices, and so forth.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A process for increasing a user base for a targeted service, comprising:
enabling an existing service user (ESU) to indicate a desire to participate in a subscription expansion promotion (SEP);
responsive to the ESU indicating a desire to participate in the SEP, determining services used by the ESU;
for at least some of the services use by the ESU, retrieving information identifying prospective service users (PSUs) from respective contact lists;
sending invitations to subscribe to the targeted service to the PSUs;
monitoring new subscription requests attributable to the invitations; and
compensating the ESU based on the new subscription requests.

2. The process of claim 1, wherein the targeted service is a multimedia content delivery (MCD) service.

3. The process of claim 2, wherein the MCD service is an Internet protocol (IP) TV service.

4. The process of claim 1, wherein the services used by the ESU are selected from the group consisting of a fixed access voice service, an IPTV service, a broadband Internet service, and a wireless telephony service.

5. The process of claim 1, further comprising, enabling the ESU to specify selectively which contact lists to use for said information retrieving.

6. The process of claim 1, further comprising, prior to the sending of invitations, filtering the PSUs based on PSU eligibility for the targeted service.

7. The process of claim 1, further comprising compensating a PSU responsive to the PSU subscribing to the targeted service within a predetermined time of the invitation.

8. The process of claim 1, wherein compensating the ESU comprises at least one of: discounting a monthly invoice of the ESU and providing the ESU with reward points based on the new subscription requests, wherein making the reward points exchangeable for goods or services.

9. A computer program product comprising computer executable instructions, stored on computer readable storage, for increasing subscriptions to a targeted service, the instructions comprising instructions for:
responsive to an existing service user (ESU) indicating a desire to participate in a subscription expansion promotion (SEP), determining services subscribed to by the ESU;
for at least some of the services subscribed to by the ESU, retrieving information identifying prospective service users (PSUs) from respective contact lists;
sending invitations to subscribe to the targeted service to PSUs;
monitoring new subscription requests attributable to the invitations; and
compensating the ESU based on the new subscription requests.

10. The computer program product of claim 9, wherein the targeted service is a multimedia content delivery (MCD) service.

11. The computer program product of claim 10, wherein the MCD service is an Internet protocol (IP) TV service.

12. The computer program product of claim 9, wherein the services subscribed to by the ESU are selected from the group consisting of a fixed access voice service, an IPTV service, a broadband Internet service, and a wireless telephony service.

13. The computer program product of claim 9, further comprising, enabling the ESU to specify selectively which contact lists to use to generate the invitations.

14. The computer program product of claim 9, further comprising, prior to the sending of invitations, filtering the PSUs based on PSU eligibility for the targeted service.

15. The computer program product of claim 9, further comprising compensating a PSU responsive to the PSU subscribing to the targeted service within a predetermined time of the invitation.

16. The computer program product of claim 9, wherein compensating the ESU includes at least one of: discounting a monthly invoice of the ESU and providing the ESU with reward points based on the new subscription requests, wherein the reward points are exchangeable for goods or services.

17. A method for promoting a service, comprising:
accessing information stored in a plurality of service specific electronic contact lists of a service user to identify an initial group of potential users;
determining which of the potential users are eligible to receive a targeted service;
sending electronic invitations to the eligible potential users to subscribe to the targeted service or to a trial of the targeted service, wherein the invitations are indicative of an identity of the service user; and
monitoring new subscription requests received in response to the invitations.

18. The method of claim 17, further comprising rating the service user based on said monitoring.

19. The method of claim 18, compensating the service user based on said rating.

20. The method of claim 17, wherein the service specific contact lists include a fixed access voice service contact list, an email contact list, and a wireless telephony contact list.

21. An application server including a processor and storage media accessible to the processor, the storage media including processor executable instructions for:
accessing information stored in a plurality of service specific electronic contact lists of a service user to identify an initial group of potential users;
determining which of the potential users are eligible to receive a targeted service;
sending electronic invitations to the eligible potential users to subscribe to the targeted service or to a trial of the targeted service, wherein the invitations are indicative of an identity of the service user; and
monitoring new subscription requests received in response to the invitations.
